(19) United States
(12) Patent Application Publication
(10) Pub. No.: US 2026/0154095 A1
(43) Pub. Date: Jun. 4, 2026

(54) ELECTRONIC DEVICE AND METHOD FOR EXECUTING SPLIT SCREEN MODE IN ELECTRONIC DEVICE

(71) Applicant: SAMSUNG ELECTRONICS CO., LTD., Suwon-si (KR)

(72) Inventors: Yonghyun KIM, Suwon-si (KR); Hyunseuk KYUNG, Suwon-si (KR); Yumi KO, Suwon-si (KR); Nina LEE, Suwon-si (KR); Yeunwook LIM, Suwon-si (KR); Woojong JANG, Suwon-si (KR)

(73) Assignee: SAMSUNG ELECTRONICS CO., LTD., Suwon-si (KR)

(21) Appl. No.: 19/274,148

(22) Filed: Jul. 18, 2025

Related U.S. Application Data
(63) Continuation of application No. PCT/KR2025/006917, filed on May 22, 2025.

(30) Foreign Application Priority Data
Nov. 29, 2024 (KR) 10-2024-0174616
Jan. 6, 2025 (KR) 10-2025-0001374

(51) Int. Cl. G06F 9/451; G06F 3/0482; G06F 3/04845

(52) U.S. Cl. CPC G06F 9/451; G06F 3/0482; G06F 3/04845; G06F 2203/04803

(57) ABSTRACT

An electronic device, including: a display; at least one processor, and memory storing instructions that cause the electronic device to: display a first image corresponding to a first application from a list of images corresponding to recently executed applications, based on a first user input for selecting the first image corresponding to the first application being received, display an object configured to recommend execution of a second application together with the first application and including information related the second application, wherein the second application is selecting using an artificial intelligence (AI) model based on information related to the first application, and based on a second user input for selecting the object being received, display an execution screen of the first application in a first area of the display and an execution screen of the second application in a second area of the display according to a split screen mode.

### CROSS-REFERENCE TO RELATED APPLICATION

This application is a bypass continuation application of International Application No. PCT/KR2025/006917, filed on May 22, 2025, which is based on and claims priority to Korean Patent Application No. 10-2024-0174616, filed in the Korean Intellectual Property Office on Nov. 29, 2024, and Korean Patent Application No. 10-2025-0001374, filed in the Korean Intellectual Property Office on Jan. 6, 2025, the disclosures of which are incorporated by reference herein in their entireties.

### BACKGROUND

### 1. Field

The disclosure relates to an electronic device and a method for executing a split screen mode in the electronic device.

### 2. Description of Related Art

An electronic device may provide a list of recently executed applications, and may operate according to a split screen mode in which a screen of the display of the electronic device is split into a plurality of sections to execute a plurality of applications.

When switching to the split screen mode while executing an application, the electronic device may display a type of a recently executed application and a type of a most used application in the second area of the display of the electronic device while displaying the running application in the first area of the display of the electronic device.

### SUMMARY

In accordance with an aspect of the disclosure, an electronic device includes: a display; at least one processor, and memory storing instructions that, when executed by the at least one processor individually or collectively, cause the electronic device to: display, through the display, a first image corresponding to a first application from a list of images corresponding to recently executed applications, based on a first user input for selecting the first image corresponding to the first application being received, display, using the display, an object configured to recommend execution of a second application together with the first application and including information related the second application, wherein the second application is selecting using an artificial intelligence (AI) model based on information related to the first application, and based on a second user input for selecting the object being received, display an execution screen of the first application in a first area of the display and an execution screen of the second application in a second area of the display according to a split screen mode.

In accordance with an aspect of the disclosure, a method for executing a split screen mode in an electronic device includes: displaying, using a display of the electronic device, a first image corresponding to a first application from a list of images corresponding to recently executed applications; based on a first user input for selecting the first image corresponding to the first application being received, displaying, using the display, an object configured to recommend execution of a second application together with the first application and including information related the second application, wherein the second application is selected using an artificial intelligence (AI) model based on information related to the first application; and based on a second user input for selecting the object corresponding to the second application being received, displaying an execution screen of the first application in a first area of the display and an execution screen of the second application in a second area of the display in the split screen mode.

In accordance with an aspect of the disclosure, a non-transitory computer-readable storage medium stores instructions which, when executed by at least one processor of a wearable electronic device, cause the wearable electronic device to: displaying, using a display of the wearable electronic device, a first image corresponding to a first application from a list of images corresponding to recently executed applications; based on a first user input for selecting the first image corresponding to the first application being received, displaying, using the display, an object configured to recommend execution of a second application together with the first application and including information related the second application, wherein the second application is selected using an artificial intelligence (AI) model based on information related to the first application; and based on a second user input for selecting the object corresponding to the second application being received, displaying an execution screen of the first application in a first area of the display and an execution screen of the second application in a second area of the display according to a split screen mode.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a block diagram illustrating an electronic device in a network environment according to an embodiment;

FIG. 2A is a block diagram illustrating an electronic device according to an embodiment; FIG. 2B is a block diagram illustrating a configuration of a processor and an AI model according to an embodiment;

FIGS. 3A and 3B are views illustrating an operation of executing a split screen mode in an electronic device according to an embodiment;

FIGS. 4A and 4B are views illustrating an operation of executing a split screen mode in an electronic device according to an embodiment;

FIG. 5 is a view illustrating an operation of executing a split screen mode in an electronic device according to an embodiment;

FIG. 6 is a view illustrating an operation of executing a split screen mode in an electronic device according to an embodiment;

FIGS. 7A and 7B are views illustrating an operation of executing a split screen mode in an electronic device according to an embodiment;

FIGS. 8A and 8B are views illustrating an operation of executing a split screen mode in an electronic device according to an embodiment;

FIG. 9 is a view illustrating a generative artificial intelligence system according to an embodiment;

FIG. 10 is a flowchart illustrating an operation of executing a split screen mode in an electronic device according to an embodiment;

FIG. 11 is a flowchart illustrating an operation of executing a split screen mode in an electronic device according to an embodiment; and

FIG. 12 is a flowchart illustrating an operation of providing a recommendation message in an electronic device according to an embodiment.

### DETAILED DESCRIPTION

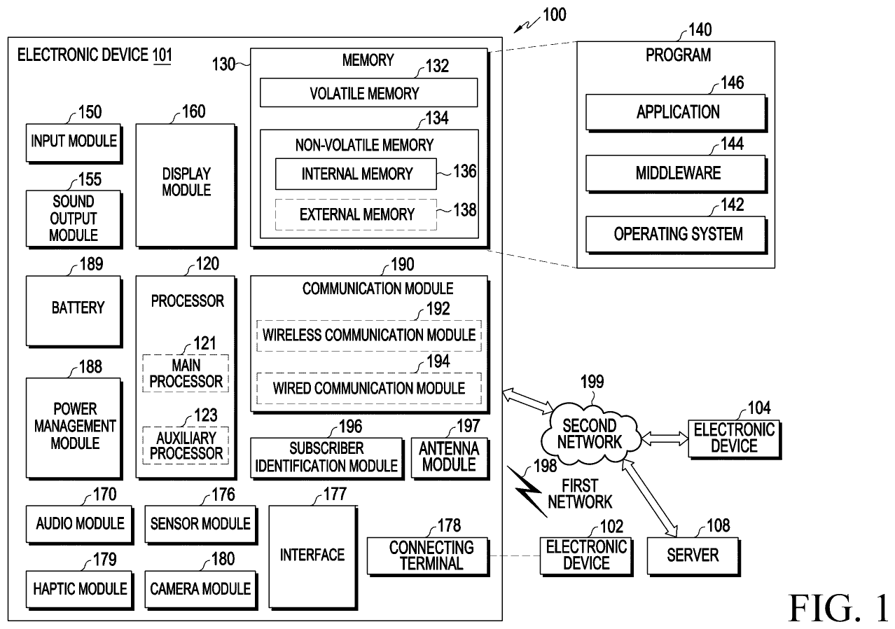

FIG. 1 is a block diagram illustrating an electronic device 101 in a network environment 100 according to an embodiment. Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence (AI) model processing. The AI model may be generated via machine learning. Such learning may be performed, e.g., by the electronic device 101 where the AI is performed or via a separate server (e.g., the server 108). Learning algorithms may include, but are not limited to, e.g., supervised learning, unsupervised learning, semi-supervised learning, or reinforcement learning. The AI model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The AI model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to an embodiment, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

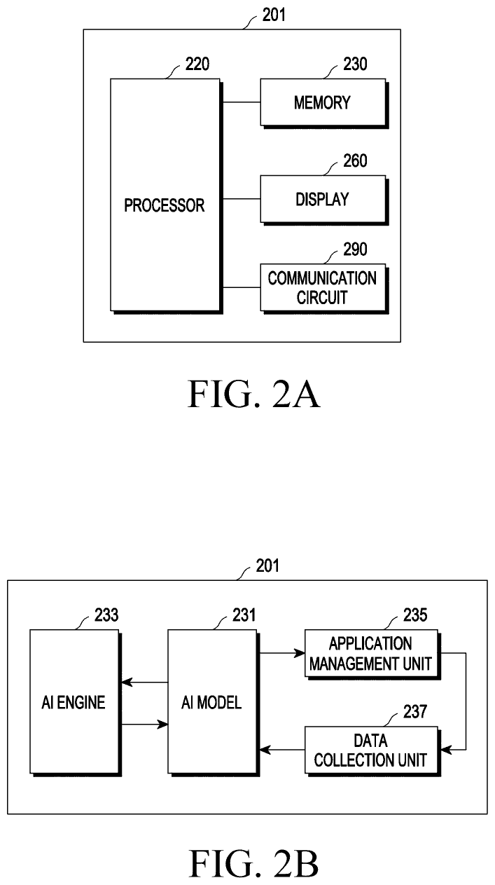

FIG. 2A is a block diagram illustrating an electronic device according to an embodiment; FIG. 2B is a block diagram illustrating a configuration of a processor and an AI model according to an embodiment.

Referring to FIG. 2A, according to an embodiment, an electronic device 201 may include a processor 220, memory 230, a display 260, and a communication circuit 290.

According to an embodiment, the processor 220 may control the overall control operation of the electronic device 201. According to an embodiment, the processor 220 may execute software (e.g., the program 140 of FIG. 1) to control at least one other component (e.g., a hardware or software component) of the electronic device 201 connected with the processor 220 and may perform data processing or computation based on instructions. An instruction according to an embodiment may include a command composed or generated in a machine language that may be processed by the electronic device 201 or the processor 220. For example, the instruction may include a command corresponding to an operation instruction used in the program.

According to an embodiment, based on receiving a selection of a first image corresponding to a first application based on a first user input from a list of images (e.g., snapshots) corresponding to recently executed applications, the processor 220 may select a second application to be recommended to be executed together with the first application in the split screen mode based on information related to the first application using an AI model 231.

According to an embodiment, the processor 220 may display a first image corresponding to the first application from the list of images corresponding to the recently executed applications and, based on the first user input for the selection of the first image corresponding to the first application being received, select the second application to be recommended to be executed together with the first application in the split screen mode based on the information related to the first application using the AI model 231.

According to an embodiment, based on receiving the selection of the first image corresponding to the first application, the processor 220 may select the application having a highest usage frequency (e.g., frequency of use) among the at least one application executed together with the first application as the second application in the split screen mode based on the information related to the first application using the AI model 231.

According to an embodiment, based on receiving the selection of the first image corresponding to the first application, the processor 220 may select an application having a longest usage time among the at least one application executed together with the first application as the second application in the split screen mode based on the information related to the first application using the AI model 231.

According to an embodiment, based on receiving the selection of the first image corresponding to the first application, the processor 220 may select a most recently used application among the at least one application executed together with the first application as the second application in the split screen mode based on the information related to the first application using the AI model 231.

According to an embodiment, based on receiving the selection of the first image corresponding to the first application, the processor 220 may analyze content (e.g., text or image) included in the last screen displayed by the first application and select an application related to the analyzed content (e.g., a result of the analyzed content) as the second application using the AI model 231.

For example, based on identifying or determining that the first application is a message application, and the last screen of the message application includes bank-related text such as “transfer” or “deposit,” the processor 220 may select a bank-related application as the second application.

According to an embodiment, the information related to the first application may include a type of the first application, a type of the application executed together with the first application in the split screen mode, a number of executions of the application executed together with the first application in the split screen mode, an execution time of the application executed together with the first application, a type of the recent application executed together with the first application, content (e.g., text or image) information included in the last screen displayed by the first application, first size information about a size (e.g., a first size) of the first area in which the first application is executed in the split screen mode, second size information about a size (e.g., a second size) of the second area in which the second application is executed in the split screen mode, and, based on a plurality of user identifiers (IDs) being present in or associated with the electronic device, user information (e.g., a user ID) corresponding to the first application.

According to an embodiment, the processor 220 may generate or update the information related to the first application using the AI model 231 when executing the first application (e.g., each time the first application is executed).

According to an embodiment, based on receiving the selection of the first image corresponding to the first application, the processor 220 may select a plurality of second applications to be recommended to be executed together with the first application in the split screen mode based on the information related to the first application using the AI model 231.

According to an embodiment, by using the AI model 231, based on the information related to the first application, the processor 220 may select a plurality of applications for which the number of executions of the application executed together with the first application in the split screen mode is equal to greater than a threshold number, a plurality of applications for which the execution time of the application executed together with the first application in the split screen mode is equal to greater than a threshold time, and/or a plurality of applications related to the analyzed content (e.g., text or image) included in the last screen displayed by the first application (the result of the analyzed content), as the plurality of second applications to be recommended to be executed together with the first application.

For example, based on determining that the first application is a message application, and the last screen information of the message application includes bank-related text such as “transfer” and call-related text such as “call me,” the processor 220 may select the bank-related application and a call-related application as the plurality of second applications.

According to an embodiment, based on determining that at least one of the electronic device and the AI model has failed to select the second application to be recommended to be executed together with the first application in the split screen mode based on the information related to the first application using the AI model 231, based on receiving the selection of the first image corresponding to the first application, the processor 220 may select a third application to be executed together with the first application based on data obtained through a server using the AI model 231.

According to an embodiment, when there is no information related to the first application, the processor 220 may select an application that is generally most frequently used with the first application in the split screen mode as the third application based on the data obtained through the server using the AI model 231.

According to an embodiment, the processor 220 may select an application that is most frequently used with the first application in the split screen mode as the third application using data of other users having similar information based on user information (e.g., age, gender, and occupation) stored in the electronic device 201 among the data obtained through the server using the AI model 231.

According to an embodiment, based on the second application being selected as a recommended application, the processor 220 may display an object (e.g., recommendation message) configured to recommend execution of the second application together with the first application and including the information related to the second application while displaying the first image corresponding to the first application through the display 260.

According to an embodiment, based on the plurality of second applications being selected as the recommended applications, the processor 220 may display an object (e.g., recommendation message) recommending selection of one second application that may be executed together with the first application among the plurality of second applications and a plurality of objects (e.g., icons or thumbnails) respectively corresponding to the plurality of second applications that may be executed together with the first application while displaying the first image corresponding to the first application through the display 260.

According to an embodiment, the processor 220 may display the plurality of objects respectively corresponding to the plurality of second applications that may be executed together with the first application, according to priority (e.g., in an order that is determined based on respective priorities), while displaying the first image corresponding to the first application through the display 260.

According to an embodiment, based on the third application being selected as a recommended application, the processor 220 may display an object (e.g., recommendation message) configured to recommend execution of the third application together with the first application and including the information related to the third application while displaying the first image corresponding to the first application through the display 260.

According to an embodiment, based on receiving a selection of the object corresponding to the second application based on an the second user input of the electronic device 201 while displaying the object (e.g., recommendation message) and the first image corresponding to the first application through the display 260, the processor 220 may switch to the split screen mode.

According to an embodiment, the processor 220 may receive a selection of the second application based on the second user input, and, when switching to the split screen mode, determine first size information about the size of a first area in which the first application has been (or is) executed in the split screen mode and second size information about the size of a second area in which the second application has been (or is) executed in the split screen mode.

According to an embodiment, based on the second application being selected according to the second user input from among the plurality of objects respectively corresponding to the plurality of second applications while displaying the object (e.g., recommendation message) and the plurality of objects respectively corresponding to the plurality of second applications and the first image corresponding to the first application through the display 260, the processor 220 may switch to the split screen mode.

According to an embodiment, based on the second application being selected according to second user input among the plurality of objects respectively corresponding to the plurality of second applications and switching to the split screen mode, the processor 220 may determine the first size information about the size of the first area in which the first application has been (or is) executed in the split screen mode and the second size information about the size of the second area in which the second application has been (or is) executed in the split screen mode.

According to an embodiment, the processor 220 may receive a selection of the object corresponding to the second application based on the second user input, switch to the split screen mode, display the execution screen of the first application in the first area of the display 260 having the first size based on the first size information, and display the execution screen of the second application in the second area of the display 260 having the second size based on the second size information.

According to an embodiment, the processor 220 may display a split screen that is split into substantially two areas including the first area and the second area which are arranged not to overlap each other through the display 260 in the split screen mode. For example, the first area and the second area may be arranged not to overlap each other in the split screen (e.g. may be arranged such that the first area does not overlap the second area, and the second area does not overlap the first area).

According to an embodiment, while the split screen is displayed on the display 260, a bar area including an indication may be displayed at an upper end of the split screen, and a lower end of the split screen may include an area including a control button.

According to an embodiment, based on receiving a selection of a first image corresponding to a first application based on a first user input from a list of images (e.g., snapshots) corresponding to recently executed applications, and determining that the first application is to be executed in the split screen mode based on the first user input, the processor 220 may select a second application to be recommended to be executed together with the first application based on information related to the first application using an AI model 231.

According to an embodiment, when the execution screen of the first application selected based on the first user input is determined to be displayed in the first area of the display 260 in the split screen mode, the processor 220 may select the application having the highest usage frequency among the at least one application executed together with the first application as the second application in the split screen mode based on the information related to the first application using the AI model 231.

According to an embodiment, when the execution screen of the first application selected based on the first user input is determined to be displayed in the first area of the display 260 in the split screen mode, the processor 220 may select the application having the longest usage time among the at least one application executed together with the first application as the second application in the split screen mode based on the information related to the first application using the AI model 231.

According to an embodiment, when the execution screen of the first application selected based on the first user input is determined to be displayed in the first area of the display 260 in the split screen mode, the processor 220 may select the recently used application among the at least one application executed together with the first application as the second application in the split screen mode based on the information related to the first application using the AI model 231.

According to an embodiment, when the execution screen of the first application selected based on the first user input is determined to be displayed in the first area of the display 260 in the split screen mode, the processor 220 may analyze content (e.g., text or image) included in the last screen provided by the first application and select the application related to the analyzed content (result of the analyzed content) as the second application using the AI model.

According to an embodiment, when the execution screen of the first application selected based on the first user input is determined to be displayed in the first area of the display 260 in the split screen mode, the processor 220 may select a plurality of objects (e.g., icons or thumbnails) respectively corresponding to the plurality of second applications to be recommended to be executed together with the first application in the split screen mode based on the information related to the first application using the AI model 231.

According to an embodiment, based on determining that the AI model 231 has failed to or is unable to select the second application to be recommended to be executed together with the first application in the split screen mode based on the information related to the first application using the AI model 231 when identifying the display of the execution screen of the first application selected based on the first user input in the first area of the display 260 in the split screen mode, the processor 220 may select a third application to be executed together with the first application based on data obtained through a server using the AI model 231.

According to an embodiment, based on the second application being selected as the recommended application, in the split screen mode, the processor 220 may display the execution screen of the first application in the first area of the display 260, and may display the object corresponding to the second application and the object (e.g., recommendation message) including the information related to the second application and configured to recommend execution of the second application together with the first application in the second area of the display 260.

According to an embodiment, based on a plurality of second applications being selected as the recommended applications, in the split screen mode, the processor 220 may display the execution screen of the first application in the first area of the display 260, and may display an object (e.g., recommendation message) including information related to the plurality of second applications and configured to recommend a selection of one second application to be executed together with the first application among the plurality of applications and a plurality of objects (e.g., icons or thumbnails) respectively corresponding to the plurality of second applications in the second area of the display 260.

According to an embodiment, the processor 220 may display the plurality of icons respectively corresponding to the plurality of second applications that may be executed together with the first application, according to priority (e.g., in an order that is determined based on respective priorities), in the second area of the display 260 in the split screen mode.

According to an embodiment, based on the third application being selected as the recommended application, the processor 220 may display the execution screen of the first application in the first area of the display 260 and may display the object corresponding to the third application and the object (e.g., recommendation message) including the information related to the third application and configured to recommend execution of the third application together with the first application in the second area of the display 260.

According to an embodiment, based on receiving a selection of the object corresponding to the second application based on the second user input while displaying the object corresponding to the second application and the object (e.g., recommendation message) including information related to the second application and configured to recommend execution of the second application together with the first application in the second area of the display 260 and displaying the execution screen of the first application in the first area of the display 260 in the split screen mode, the processor 220 may display the execution screen of the first application in the first area of the display 260 and display the execution screen of the second application in the second area of the display 260 in the split screen mode.

According to an embodiment, based on the second application being selected based on the second user input from among the plurality of objects respectively corresponding to the plurality of second applications while displaying the plurality of objects (e.g., icons or thumbnails) respectively corresponding to the plurality of second applications and the object (e.g., recommendation message) including the information related to the plurality of second applications and configured to recommend a selection of one second application to be executed together with the first application from among the plurality of applications in the second area of the display 260 and displaying the execution screen of the first application in the first area of the display 260 in the split screen mode, the processor 220 may display the execution screen of the first application in the first area of the display 260 and display the execution screen of the second application in the second area of the display 260 in the split screen mode.

According to an embodiment, based on receiving a selection of the object corresponding to the second application based on the second user input while displaying the object corresponding to the second application and the object (e.g., recommendation message) including information related to the second application and configured to recommend execution of the second application together with the first application in the second area of the display 260 and displaying the execution screen of the first application in the first area of the display 260 in the split screen mode, the processor 220 may determine first size information about the size of the first area in which the first application has been (or is) executed in the split screen mode and second size information about the size of the second area in which the second application has been (or is) executed in the split screen mode.

According to an embodiment, based on the second application being selected according to the first user input from among the plurality of objects respectively corresponding to the plurality of applications while displaying the plurality of objects (e.g., icons or thumbnails) respectively corresponding to the plurality of second applications and the object (e.g., recommendation message) including the information related to the plurality of second applications and configured to recommend a selection of one second application to be executed together with the first application from among the plurality of applications in the second area of the display 260 and displaying the execution screen of the first application in the first area of the display 260 in the split screen mode, the processor 220 may determine first size information about the size of the first area in which the first application has been (or is) executed in the split screen mode and second size information about the size of the second area in which the second application has been (or is) executed in the split screen mode.

According to an embodiment, based on receiving a selection of the second application based on the second user input, the processor 220 may display the execution screen of the first application in the first area of the display 260 having the first size based on the first size information and display the execution screen of the second application in the second area of the display 260 having the second size based on the second size information.

According to an embodiment, the processor 220 may divide the display 260 in the split screen mode into areas having different numbers, sizes, and positions based on the type of the electronic device.

For example, based on the electronic device being a vertically foldable electronic device, the processor 220 may provide a plurality of areas that divide the display horizontally in the split screen mode and, based on the electronic device being a horizontally foldable electronic device, the processor 220 may provide a plurality of areas that divide the display vertically or provide a plurality of areas that divide the display vertically and horizontally.

According to an embodiment, the processor 220 may divide the display 260 in the split screen mode into areas having different numbers, sizes, and positions based on the type of the electronic device and the type of the first application being executed based on the user input.

For example, based on the electronic device being a horizontally foldable electronic device, the processor 220 may provide a plurality of areas that divide the display vertically based on the type (e.g., a feature) of the first application being executed in the split screen mode or may provide a plurality of areas that divide the display horizontally.

According to an embodiment, based on receiving a voice command (e.g., “Run the message application in split screen mode”) instructing to execute the first application in the split screen mode, the processor 220 may select a second application to be recommended to be executed together with the first application based on the information related to the first application using the AI model 231, switch to the split screen mode, and display the execution screen of the first application in the first area of the display 260 and display the execution screen of the second application in the second area of the display 260.

According to an embodiment, based on receiving a selection of the object (e.g., recommendation message) corresponding to the second application based on the second user input while displaying the object (e.g., recommendation message) and the first image corresponding to the first application selected based on the first user input from the list of images corresponding to the recently executed applications through the display 260 in a state in which the electronic device 201 is connected to the external electronic device through the communication circuit 290, the processor 220 may transmit information about the application to the external electronic device through the communication circuit 290 to display the execution screen of the second application through the display of the external electronic device and display the execution screen of the first application on the display 260.

According to an embodiment, based on receiving a selection of the second application according to the second user input, the processor 220 may transmit the information about the second application to the external electronic device through the communication circuit 290 to display the execution screen of the second application through the display of the external electronic device, display the execution screen of the first application in the first area of the display 260 and display the execution screen of the second application selected based on the user input in the second area of the display 260 in the split screen mode.

According to an embodiment, the memory 230 may be implemented to be substantially the same or similar to the memory 130 of FIG. 1.

According to an embodiment, the memory 230 may store an AI model 231, and the AI model 231 may include a large multi-modal model (LMM) as a generative AI model and may be an on-device model or an external AI model.

According to an embodiment, at least a portion of the on-device AI model may operate as an external AI model.

According to an embodiment, the on-device AI model may process sensitive information, such as private information, and the external AI model may process information other than the sensitive information.

According to an embodiment, the on-device AI model may be an AI model embedded in the electronic device 201 that may provide various functions without using a network (e.g., without transmitting or receiving information related to the various functions over a communications network).

According to an embodiment, a plurality of AI models may be stored in the memory 230.

According to an embodiment, the plurality of AI models may be AI models trained based on a designated type of training algorithm and implemented to receive various types of data (or content), perform calculations, and output or obtain result data.

According to an embodiment, the plurality of AI models may include generative AI models.

According to an embodiment, the generative AI model may generate and output new content (e.g., at least one of text, images, and computer code) based on what it has learned in response to an input prompt. For example, training may be performed on the electronic device 201 to use designated types of data as input data and output specific types of result data as output data based on a machine learning algorithm or deep learning algorithm to generate a plurality of AI models (e.g., machine learning models or deep learning models) that are then stored in the electronic device 201, or trained AI models may be transferred from an external electronic device (e.g., an external server) and stored. For example, the electronic device 101 may output input data as output data of the model trained through designated types of AI based on the machine learning algorithm or deep learning algorithm. The machine learning algorithms may include supervised algorithms, such as linear regression and logistic regression, unsupervised algorithms, such as clustering, visualization and dimensionality reduction, and association rule learning, and reinforcement algorithms, and the deep learning algorithms may include artificial neural networks (ANNs), deep neural networks (DNNs), and convolution neural networks (CNN) but, without being limited thereto, may further include other various learning algorithms. The trained AI model may include at least one computational operation (e.g., convolution layer or pooling layer) for computing input data and may be implemented to output result data by performing computation on the input data based on the at least one computational operation.

According to an embodiment, the memory 230 may store an application that may connect to an external AI model.

According to an embodiment, the display 260 may be implemented to be substantially identical or similar to the display module 160 of FIG. 1.

According to an embodiment, the display 260 may display the object (e.g., recommendation message) providing the second application as a recommended application and the first image corresponding to the first application selected based on the first user input from the list of first images corresponding to the recently executed applications.

According to an embodiment, the display 260 display the execution screen of the first application selected based on the first user input in the first area of the display 260 and the execution screen of the second application (e.g., the recommended application) in the second area of the display 260 in the split screen mode.

According to an embodiment, the communication circuit 290 may establish a communication connection with an external electronic device (e.g., at least one of another electronic device and a server) in various kinds of communication schemes and transmit and/or receive data. As described above, the communication method may include a communication method for establishing a direct communication connection such as Bluetooth and Wi-Fi direct, a communication method using an access point (AP) (e.g., Wi-Fi communication), or a communication method using cellular communication using a base station (e.g., at least one of 3G, 4G/LTE, and 5G). The communication circuit 290 may be implemented as the communication module 190 described above in FIG. 1, so a redundant description thereof is omitted.

Referring to FIG. 2B, according to an embodiment, the electronic device 201 may include an AI model 231, an AI engine 233, an application management unit 235, and a data collection unit 237.

According to an embodiment, the AI engine 233, the application management unit 235, and the data collection unit 237 may be stored in the memory 230 or configured separately.

According to an embodiment, the operations of the application management unit 235 and the data collection unit 237 may be performed using the processor 220.

According to an embodiment, the AI model 231 may transmit application-related data received from the data collection unit 237 to the AI engine 233.

According to an embodiment, the application-related data may include first information related to the first application that is running and second information related to a previous execution of the first application.

According to an embodiment, the AI model 231 may generate an executable intent and a recommendation message recommending execution of the second application together with the first application in the split screen mode based on result data calculated based on the first information and second information received from the AI engine 233, and transmit the executable intent and the recommendation message to the processor 220.

According to an embodiment, an application intent is a message object that may be used to request a task and may be used to execute the second application (e.g., the recommended application).

According to an embodiment, an intent may be a tool that helps integrate application functions with various system functions, such as AI models, shortcuts, or widgets, and may create customized actions and call them through the system interface. Customized actions may include parameters that allow the user to designate additional detailed information, making the interaction more flexible and relevant.

According to an embodiment, the application intent may define an entity, which may be an object representing core application data. The entity may be exposed to the system to allow the user to interact with specific application content without directly opening the application.

According to an embodiment, a query included in the application intent may be used to retrieve the entity according to the user input or other criteria.

According to an embodiment, the application intent may provide an application function as a further personalized experience. For example, it may create a shortcut by combining several application actions and configure a widget for quickly accessing a specific application function.

According to an embodiment, when receiving application-related data (first information related to the first application which is running and second information related to the previous execution of the first application) from the AI model 231, the AI engine 233 may produce (calculate) the result data for generating a recommendation message and an executable intent using a prompt or retrieval-augmented generation (RAG) and transmit the result data to the AI model 231.

According to an embodiment, the application management unit 235 may transmit information related to the first application selected based on the user input from the list of images corresponding to the recently executed applications (e.g., at least one of first information related to the first application which is running and second information related to the previous execution of the first application), as application data, to the data collection unit 237.

According to an embodiment, the application management unit 235 may transmit information related to the first application selected based on the user input in the split screen mode (e.g., at least one of first information related to the first application which is running and second information related to the previous execution of the first application), as application-related data, to the data collection unit 237.

According to an embodiment, the data collection unit 237 may receive application-related data received from the application management unit 235 and transmit the received application-related data to the AI model 231.

According to an embodiment, the data collection unit 237 may determine at least one of the type (e.g., application name) of the first application which is running, when a plurality of user IDs are present in the electronic device, information about the user using the running first application, the type of the application executed together with the first application in the split screen mode, first size information related to the size of the first area of the display 260 displaying the execution screen of the first application and the size of the second area of the display 260 displaying the execution screen of the application executed together with the first application in the split screen mode, or state information (e.g., information about the battery capable of switching to the split screen mode) about the electronic device, or information about connection to the external electronic device, and electronic device type information (e.g., foldable electronic device, tablet, or wearable electronic device) from the application-related data, and store (collect) it.

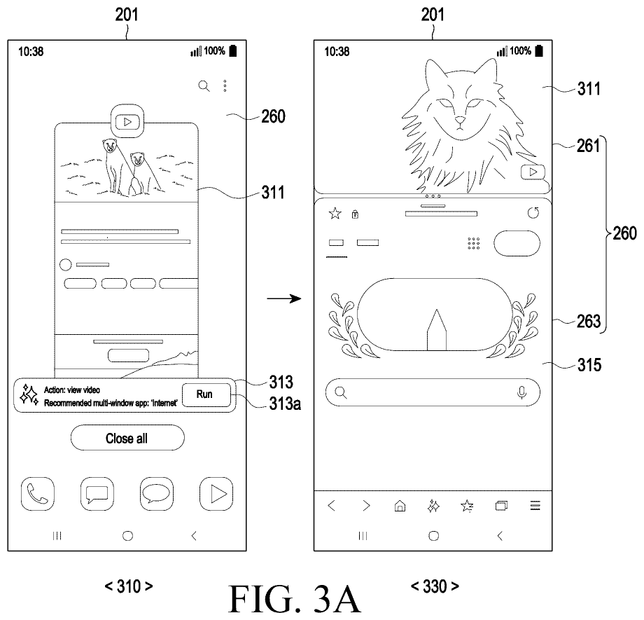

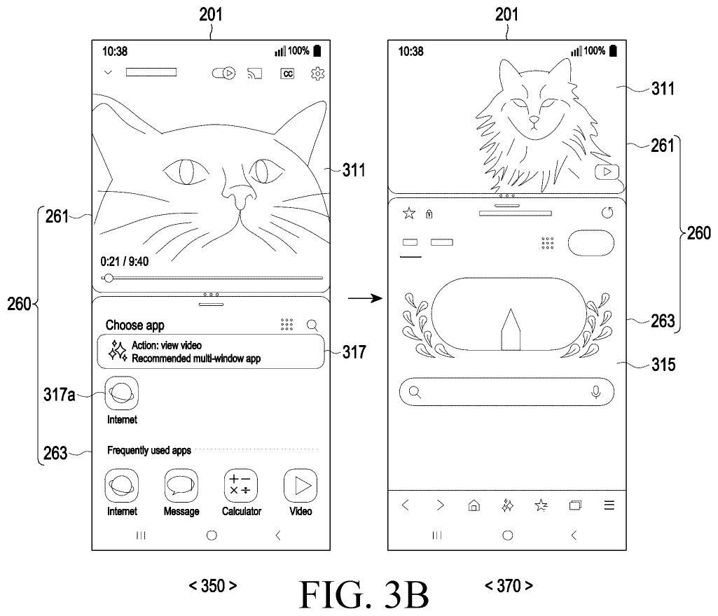

FIGS. 3A and 3B are views illustrating an operation of executing a split screen mode in an electronic device according to an embodiment.

Referring to FIG. 3A, as illustrated in screen 310, according to an embodiment, based on receiving a selection of a video application 311 based on the first user input from the list of images corresponding to the recently executed applications, the electronic device 201 (e.g., at least one of the electronic device of FIG. 1 and the electronic device 201 of FIGS. 2A and 2B) may select the Internet application 315 having the highest usage frequency among the applications used together with the video application 311 in the split screen mode based on information related to the video application 311 using the AI model (e.g., the AI model 231 of FIG. 2B).

According to an embodiment, the electronic device 201 may display a recommendation message 313 that displays the Internet application which may be executed together with the video application 311, as a recommended application, while displaying the first image corresponding to the video application 311 through the display 260 of the electronic device 201.

According to an embodiment, the electronic device 201 may receive a selection 313a of the Internet application based on the second user input through the recommendation message 313.

As illustrated in screen 330, according to an embodiment, based on receiving a selection of an object 313a corresponding to the Internet application based on the second user input through the recommendation message 313, the electronic device 201 (e.g., at least one of the electronic device of FIG. 1 and the electronic device 201 of FIGS. 2A and 2B) may switch to the split screen mode and display the execution screen of the video application 311 in the first area 261 of the display 260 and display the execution screen of the Internet application 315 in the second area 263 of the display 260 in the split screen mode.

According to an embodiment, when switching to the split screen mode, the electronic device 201 may determine first size information about the size of the first area of the display 260 where the video application 311 has been (or is) executed in the split screen mode and second size information about the size of the second area of the display 260 where the Internet application 315 has been (or is) executed in the split screen mode.

According to an embodiment, the electronic device 201 may display the execution screen of the video application in the first area 261 of the display 260 having the first size based on the first size information and display the execution screen of the Internet application 315 in the second area of the display 260 having the second size based on the second size information.

Referring to FIG. 3B, as illustrated in screen 350, according to an embodiment, based on receiving a selection of a first image corresponding to the video application 311 based on the first user input from the list of images corresponding to the recently executed applications and determining that the video application is to be executed in the split screen mode based on the user input, the electronic device 201 (e.g., at least one of the electronic device of FIG. 1 and the electronic device 201 of FIGS. 2A and 2B) may select the Internet application 315 having the highest usage frequency among the applications used together with the video application 311 in the split screen mode based on information related to the video application using the AI model (e.g., the AI model 231 of FIG. 2B).

According to an embodiment, in the split screen mode, the electronic device 201 may display the execution screen of the video application in the first area 261 of the display 260 of the electronic device 201 and display the recommendation message 317 displaying the Internet application as a recommended application together with the object 317a corresponding to the Internet application that may be executed together with the video application 311 in the second area 263 of the display 260.

According to an embodiment, the electronic device 201 may receive a selection of the object 317a corresponding to the Internet application based on the second user input.

As illustrated in screen 370, according to an embodiment, based on receiving a selection of the object 317a corresponding to the Internet application based on the second user input, the electronic device 201 (e.g., at least one of the electronic device of FIG. 1 and the electronic device 201 of FIGS. 2A and 2B) may switch to the split screen mode and display the execution screen of the video application 311 in the first area 261 of the display 260 and display the execution screen of the Internet application 315 in the second area 263 of the display 260 in the split screen mode.

According to an embodiment, when switching to the split screen mode, the electronic device 201 may determine first size information about the size of the first area of the display 260 where the video application 311 has been (or is) executed in the split screen mode and second size information about the size of the second area of the display 260 where the Internet application 315 has been (or is) executed.

According to an embodiment, the electronic device 201 may display the execution screen of the video application 311 in the first area 261 of the display 260 having the first size based on the first size information and display the execution screen of the Internet application 315 in the second area of the display 260 having the second size based on the second size information.

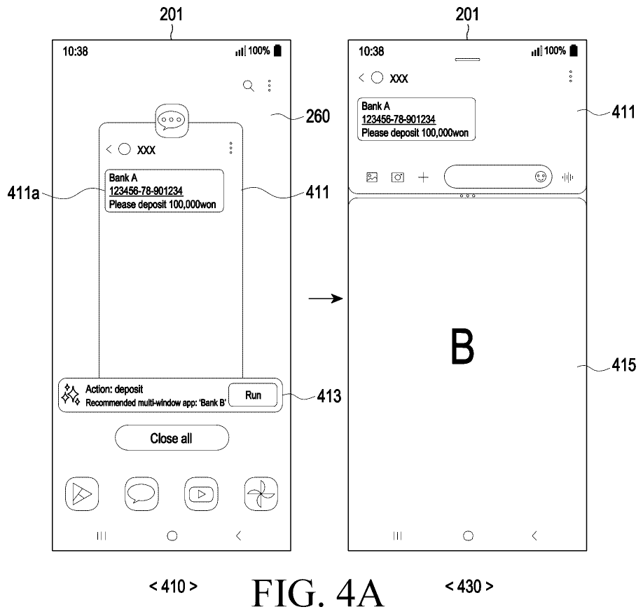

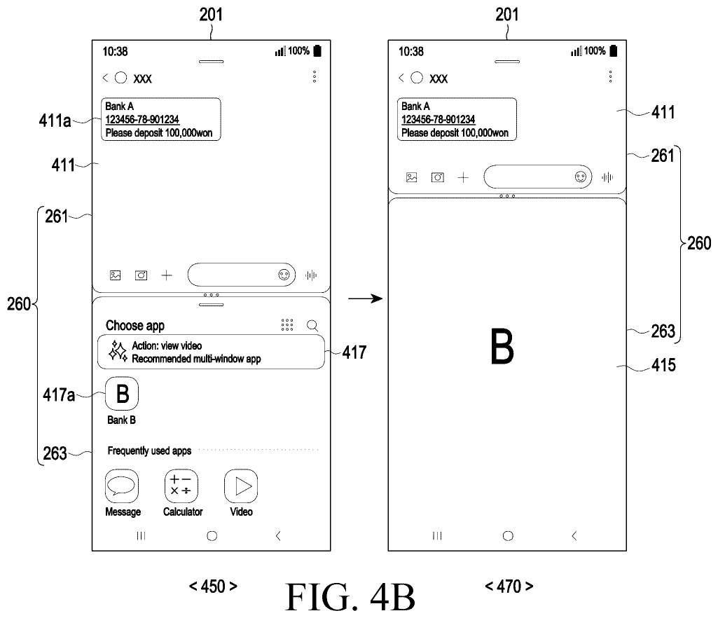

FIGS. 4A and 4B are views illustrating an operation of executing a split screen mode in an electronic device according to an embodiment.

Referring to FIG. 4A, as illustrated in screen 410, according to an embodiment, based on receiving a selection of a message application 411 based on the first user input from the list of the images corresponding to the recently executed applications, the electronic device 201 (e.g., at least one of the electronic device of FIG. 1 and the electronic device 201 of FIGS. 2A and 2B) may analyze the content 411a included in the last screen displayed by the message application 411 using the AI model (e.g., the AI model 231 of FIG. 2B) and select a bank B application 415 which is frequently used by the user of the electronic device 201 for depositing money in relation to the results (e.g., “bank A,” “Please deposit money”) of the analyzed content, based on the results (e.g., “bank A,” “Please deposit money”) of the analyzed content, as the recommended application to be recommended to be executed together with the message application 411.

According to an embodiment, the electronic device 201 may display a recommendation message 413 that displays the bank B application which may be executed together with the message application 411, as a recommended application, while displaying the first image corresponding to the message application 411 through the display 260 of the electronic device 201.

According to an embodiment, the electronic device 201 may determine a selection of the bank B application based on the second user input through the recommendation message 413.

As illustrated in screen 430, according to an embodiment, based on receiving a selection of the bank B application based on the second user input through the recommendation message 413, the electronic device 201 (e.g., at least one of the electronic device of FIG. 1 and the electronic device 201 of FIGS. 2A and 2B) may switch to the split screen mode and display the execution screen of the message application 411 in the first area 261 of the display 260 and display the execution screen of the bank B application 415 in the second area 263 of the display 260 in the split screen mode.

According to an embodiment, when switching to the split screen mode, the electronic device 201 may determine first size information about the size of the first area of the display 260 where the message application 411 has been (or is) executed in the split screen mode and second size information about the size of the second area of the display 260 where the bank B application 415 has been (or is) executed.

According to an embodiment, the electronic device 201 may display the execution screen of the message application 411 in the first area 261 of the display 260 having the first size based on the first size information and display the execution screen of the bank B application 415 in the second area of the display 260 having the second size based on the second size information.

Referring to FIG. 4B, as illustrated in screen 450, according to an embodiment, based on receiving a selection of a message application 411 based on the first user input from the list of the images corresponding to the recently executed applications, and determining that the message application is to be executed in the split screen mode based on the first user input, the electronic device 201 (e.g., at least one of the electronic device of FIG. 1 and the electronic device 201 of FIGS. 2A and 2B) may analyze the content 411a included in the last screen information displayed by the message application 411 using the AI model (e.g., the AI model 231 of FIG. 2B) and select a bank B application 415 which is frequently used by the user of the electronic device for depositing money in relation to the results (e.g., “bank A,” “Please deposit money”) of the analyzed content, based on the results (e.g., “bank A,” “Please deposit money”) of the analyzed content, as the recommended application to be recommended to be executed together with the message application 411.

According to an embodiment, in the split screen mode, the electronic device 201 may display the execution screen of the message application in the first area 261 of the display 260 of the electronic device 201 and display the recommendation message 417 displaying the bank B application as a recommended application together with the object 417a corresponding to the bank B application that may be executed together with the message application 411 in the second area 263 of the display 260.

According to an embodiment, the electronic device 201 may receive a selection of the object 417a corresponding to the bank B application based on the second user input.

As illustrated in screen 470, according to an embodiment, based on receiving a selection of the object 417a corresponding to the bank B application based on the second user input, the electronic device 201 (e.g., at least one of the electronic device of FIG. 1 and the electronic device 201 of FIGS. 2A and 2B) may switch to the split screen mode and display the execution screen of the message application 411 in the first area 261 of the display 260 and display the execution screen of the bank B application 415 in the second area 263 of the display 260 in the split screen mode.

According to an embodiment, when switching to the split screen mode, the electronic device 201 may determine first size information about the size of the first area of the display 260 where the message application 411 has been (or is) executed in the split screen mode and second size information about the size of the second area of the display 260 where the bank B application 415 has been (or is) executed.

According to an embodiment, the electronic device 201 may display the execution screen of the message application 411 in the first area 261 of the display 260 having the first size based on the first size information and display the execution screen of the bank B application 415 in the second area of the display 260 having the second size based on the second size information.

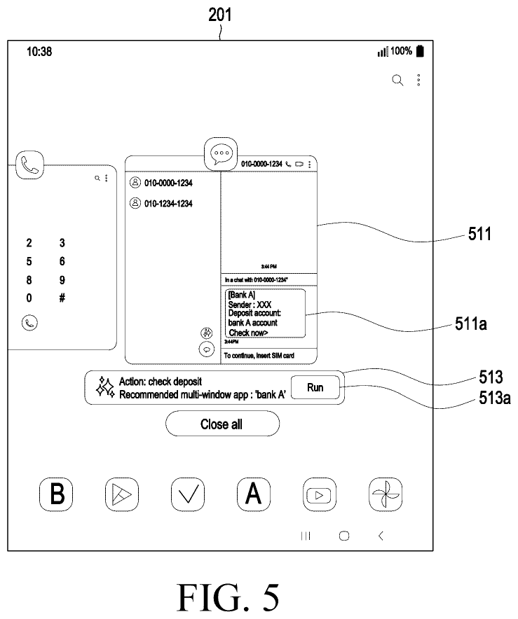

FIG. 5 is a view illustrating an operation of executing a split screen mode in an electronic device according to an embodiment.

Referring to FIG. 5, according to an embodiment, based on receiving a selection of a message application 511 based on the first user input from the list of the images corresponding to the recently executed applications, the electronic device 201 (e.g., at least one of the electronic device of FIG. 1 and the electronic device 201 of FIGS. 2A and 2B) may analyze the content 511a included in the last screen displayed by the message application 511 using the AI model (e.g., the AI model 231 of FIG. 2B) and select a bank A application, rather than the bank B which is frequently used by the user of the electronic device 201 for depositing money in relation to the results (e.g., “sender,” “bank A”) of the analyzed content, based on the results (e.g., “sender,” “bank A”) of the analyzed content, as the recommended application to be recommended to be executed together with the message application 411.

According to an embodiment, the first user input for selecting the application from the list of the images corresponding to the recently executed applications may include the user's vertical/horizontal slide input.

According to an embodiment, based on the first image corresponding to the first application from the list of the images corresponding to the recently executed applications being displayed in the center of the screen of the display according to a slide input received from the user, the electronic device 201 may display at least one recommended application that may be executed together with the first application at a lower end of the first image.

According to an embodiment, the electronic device 201 may display a recommendation message 513 that displays the bank A application which may be executed together with the message application 511, as a recommended application, while displaying the first message corresponding to the message application 511 through the display 260 of the electronic device 201.

According to an embodiment, the electronic device 201 may receive a selection 513a of the bank A application based on the second user input through the recommendation message 513.

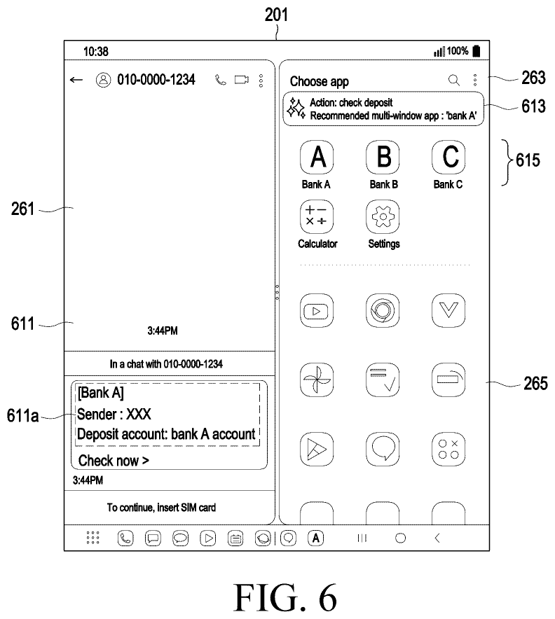

FIG. 6 is a view illustrating an operation of executing a split screen mode in an electronic device according to an embodiment.

Referring to FIG. 6, according to an embodiment, based on receiving a selection of a message application 611 based on the first user input from the list of the images corresponding to the recently executed applications and determining that the message application is to be executed in the split screen mode based on the first user input, the electronic device 201 (e.g., at least one of the electronic device of FIG. 1 and the electronic device 201 of FIGS. 2A and 2B) may analyze the content 611a included in the last screen displayed by the message application 611 using the AI model (e.g., the AI model 231 of FIG. 2B) and select a plurality of bank applications 615 for confirming deposit in relation to the results (e.g., “sender,” “bank A”) of the analyzed content, based on the results (e.g., “sender,” “bank A”) of the analyzed content, as the recommended applications to be recommended to be executed together with the message application 611.

According to an embodiment, based on the plurality of bank applications 615 being selected as recommended applications to be recommended to be executed together with the message application 611, the electronic device 201 may display the message application 611 in the first area 261 of the display 260, display a recommendation message 613 displaying the plurality of bank applications as the recommended applications and a plurality of objects 615 corresponding to the plurality of bank applications that may be executed together with the message application 611 in the second area 263 of the display 260, and display the objects corresponding to the applications frequently used by the user of the electronic device in the third area 265 of the display 260.

According to an embodiment, the electronic device 201 may display the plurality of objects corresponding to the plurality of bank applications according to the usage frequency by the user of the electronic device or in order of priority based on the relevance to the content 611a included in the last screen displayed by the message application 611.

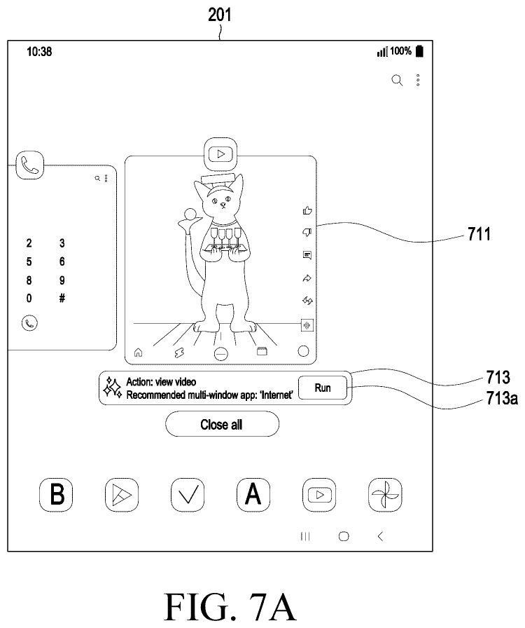

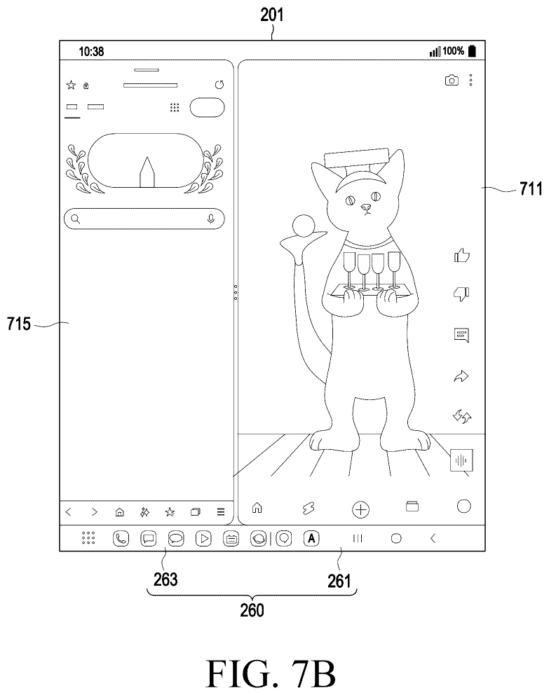

FIGS. 7A and 7B are views illustrating an operation of executing a split screen mode in an electronic device according to an embodiment.

Referring to FIG. 7A, according to an embodiment, based on receiving a selection of a video application 711 based on the first user input from the list of images corresponding to the recently executed applications, the electronic device 201 (e.g., at least one of the electronic device of FIG. 1 and the electronic device 201 of FIGS. 2A and 2B) may select the Internet application 715 having the highest usage frequency among the applications used together with the video application 711 in the split screen mode based on information related to the video application 711 using the AI model (e.g., the AI model 231 of FIG. 2B).

According to an embodiment, the electronic device 201 may display a recommendation message 713 that displays the Internet application which may be executed together with the video application 711, as a recommended application, while displaying the first image corresponding to the video application 711 through the display 260 of the electronic device 201.

According to an embodiment, the electronic device 201 may receive a selection of an object 713a corresponding to the Internet application based on the second user input through the recommendation message 713.

Referring to FIG. 7B, according to an embodiment, based on receiving a selection of the object 713a corresponding to the Internet application based on the second user input through the recommendation message 713, the electronic device 201 (e.g., at least one of the electronic device of FIG. 1 and the electronic device 201 of FIGS. 2A and 2B) may switch to the split screen mode.

According to an embodiment, based on determining first location information indicating that, in the split screen mode, the video application 711 and the Internet application 715 are displayed in the first area and second area of the display 260 which are split left and right, the electronic device 201 may split the first area and the second area left and right in the split screen mode based on the first location information, display the execution screen of the video application 711 in the first area 261 of the display 260 and display the execution screen of the Internet application 715 in the second area 263 of the display 260.

According to an embodiment, using the AI model (e.g., the AI model 231 of FIG. 2B), the electronic device 201 may vertically split the first area and the second area of the display 260 in the split screen mode based on the characteristics of the video application (e.g., if the display areas are divided horizontally for a video with a vertical aspect ratio, the aspect ratio of the video may be distorted), display the execution screen of the video application 711 in the first area 261 of the display and display the execution screen of the Internet application 715 in the second area 263 of the display 260.

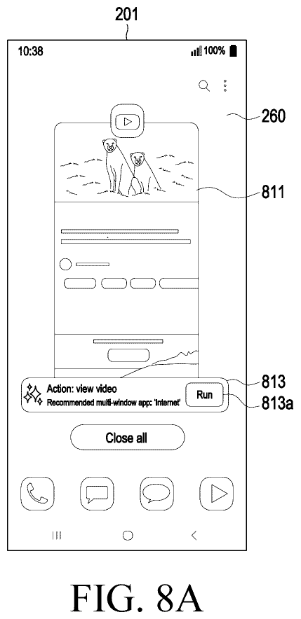

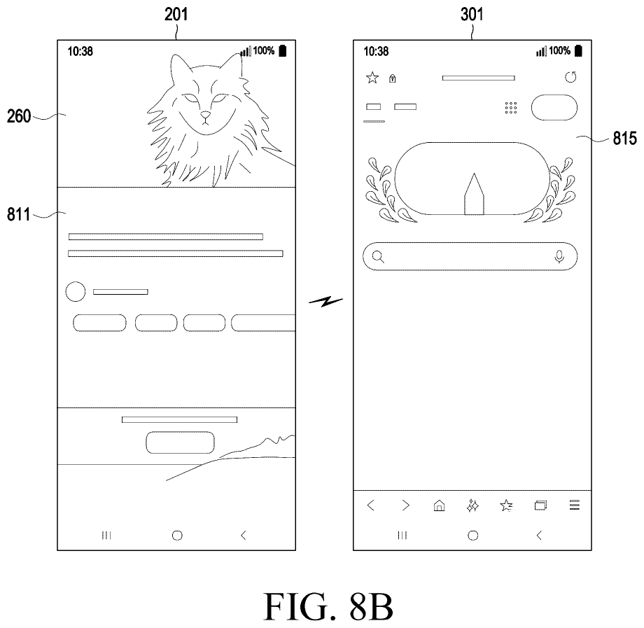

FIGS. 8A and 8B are views illustrating an operation of executing a split screen mode in an electronic device according to an embodiment.

Referring to FIG. 8A, according to an embodiment, based on receiving a selection of a video application 811 based on the second user input from the list of images corresponding to the recently executed applications in a state in which the electronic device 201 is connected to the external electronic device 301 through the communication circuit (e.g., the communication circuit 290 of FIG. 2A) of the electronic device, the electronic device 201 (e.g., at least one of the electronic device of FIG. 1 and the electronic device 201 of FIGS. 2A and 2B) may select the Internet application 815 having the highest usage frequency among the applications used together with the video application 811 in the split screen mode based on information related to the video application 811 using the AI model (e.g., the AI model 231 of FIG. 2B).

According to an embodiment, the electronic device 201 may display a recommendation message 813 that displays the Internet application 815 which may be executed together with the video application 811, as a recommended application, while displaying the first image corresponding to the video application 811 through the display 260 of the electronic device 201.

According to an embodiment, the electronic device 201 may receive a selection of an object 813a corresponding to the Internet application based on the second user input through the recommendation message 813.

Referring to FIG. 8B, according to an embodiment, based on receiving a selection of the object 813a corresponding to the Internet application based on the second user input through the recommendation message 813, the electronic device 201 (e.g., at least one of the electronic device of FIG. 1 and the electronic device 201 of FIGS. 2A and 2B) may transmit information about the Internet application to the external electronic device 301 through the communication circuit (e.g., the communication circuit 290 of FIG. 2A) of the electronic device 201 so that the execution of the Internet application 815 may be displayed through the display of the external electronic device 301 and display the execution screen of the video application 811 on the display 260.

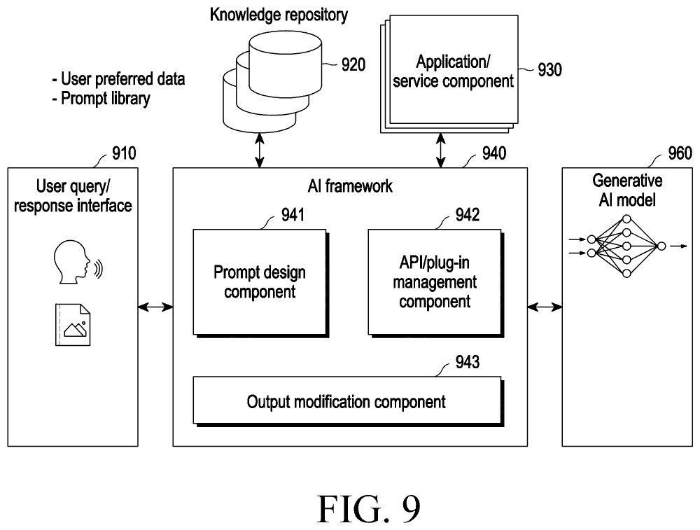

FIG. 9 is a view illustrating a generative AI system according to an embodiment.

According to an embodiment, a user query/response interface 910 may receive the user input. The user input may be in the form of at least one of natural language, images, and video, but embodiments are not limited thereto. Further, context information may also be transmitted when the user input is transmitted. The context information may include various additional pieces of information at the time of the user input. For example, the additional information may include information about the application being currently used by the user or location information about the user. Further, the user input may be a combination of the above-described natural language, image, sound, and context information. Further, the user input may be in a different form, such as selecting a menu. The user query/response interface 910 may output the results of the generative AI system to the user. The output may be in natural-language forms or specific content forms or may be provided in the form, like an action requested by the user. The user query/response interface 910 may output the results of the generative AI system to the user. The output may be in natural-language forms or specific content forms or may be provided in the form, such as an action requested by the user.

The AI framework 940 may receive the user input and coordinate and control each component necessary to perform the user intention based on the user query.

The user input received by the user query/response interface 910 may be transmitted to the prompt design component 941. The prompt design component 941 may be used to generate a prompt suitable for entry of the user input to a large language model (LLM) or LMM. The prompt design component 941 may be an AI component that uses a machine learning algorithm or a neural network to develop a better prompt over time. The prompt design component 941 may generate a prompt by accessing a knowledge component including user preference data, a prompt library, and a prompt example based on the user input, and may transfer the generated prompt to the LMM or LMM.

When there is a request for additional information when transferring the user input as the input of the generative AI model 360, the API/plug-in management component 942 may perform a role of communicating with external information. The API/plug-in management component 942 may establish a channel capable of communicating with the outside of the AI interface through the API, and allow access to various data sources (e.g., the knowledge repository 920) through the established channel. When the application or service is required to perform an action of finally performing a user input rather than an intermediate result, the API/plug-in management component 942 may request the corresponding action from the application/service component 930 through the API. Information obtained from the outside may be used to generate the prompt in the prompt design component 941 along with the user input, or may be transferred as an input to the generative model.

The output modification component (also referred to as a refiner component) 943 may fine-tune the output from the generative model. For example, the output modification component 943 may verify whether the content generated through at least one of the LLM and the LMM is irrelevant, contains biased content, or contains harmful content. Further, the output modification component 943 may determine the extent to which it matches a desired result of the user, and, if an additional process is required, proceed with the corresponding process. The output modification component 943 may further configure hints for avoiding unwanted outputs and provide them to the user.

The generative AI model 960 may generally refer to an AI neural network that may generate new types of data based on user input information. The generative AI model 960 may include at least one of a model for generating an image and a model for generating a language. Examples of models that generate images may include generative advertising network (GAN) and variable auto encoder (VAE), and diffusion-based generative models that use VAE and transformer structures. The language-generating model may be a model trained to output the most statistically appropriate output based on the input value, such as CHAT-GPT 3 and CHAT-GPT 4. There are also LMMs that may recognize various forms of data input, such as text, images, and voices, and generate corresponding new data.

According to an embodiment, an electronic device (e.g., at least one of the electronic device 101 of FIG. 1 and the electronic device 201 of FIGS. 2A and 2B) may include a display (e.g., at least one of the display module 160 of FIG. 1 and the display 260 of FIG. 2A), at least one processor (e.g., at least one of the processor 120 of FIG. 1 and the processor 220 of FIG. 2A), and memory (e.g., at least one of the memory 130 of FIG. 1 and the memory 230 of FIG. 2A) storing instructions. According to an embodiment, the instructions may, when executed by the at least one processor individually or collectively, cause the electronic device to display, using the display, a first image corresponding to a first application from a list of images corresponding to recently executed applications. According to an embodiment, the instructions may, when executed by the at least one processor individually or collectively, cause the electronic device to, based on receiving a first user input for selecting the first image corresponding to the first application, display, through the display, an object, which may be configured to recommend execution of a second application together with the first application and may include information related the second application. The second application may be selected using an AI model based on information related to the first application. According to an embodiment, the instructions may, when executed by the at least one processor individually or collectively, cause the electronic device to, based on receiving a second user input for selecting the object corresponding to the second application, display an execution screen of the first application in a first area of the display and an execution screen of the second application in a second area of the display according to a split screen mode.

According to an embodiment, the instructions may, when executed by the at least one processor individually or collectively, cause the electronic device to, select, as the second application, an application having a highest usage frequency from among applications used together with the first application in the split screen mode.

According to an embodiment, the instructions may, when executed by the at least one processor individually or collectively, cause the electronic device to, select, as the second application, an application having a longest usage time from among applications used together with the first application in the split screen mode.

According to an embodiment, the instructions may, when executed by the at least one processor individually or collectively, cause the electronic device to, using the AI model, analyze content included in a last screen displayed by the first application based on the information related to the first application and select, as the second application, an application related to the analyzed content.

According to an embodiment, the instructions may, when executed by the at least one processor individually or collectively, cause the electronic device to, based on the information related to the first application, select a plurality of second applications recommended to be executed together with the first application using the AI model. According to an embodiment, the instructions may, when executed by the at least one processor individually or collectively, cause the electronic device to display, using the display, a plurality of objects corresponding to the plurality of second applications while the first image corresponding to the first application is displayed.

According to an embodiment, the instructions may, when executed by the at least one processor individually or collectively, cause the electronic device to, based on determining that the AI model is unable to select an application recommended to be executed together with the first application based on the information related to the first application, select, using the AI model a third application recommended to be executed together with the first application based on data obtained through a server.

According to an embodiment, the instructions may, when executed by the at least one processor individually or collectively, cause the electronic device to determine first size information about a size (e.g., a first size) of a first area and second size information about a size (e.g., a second size) of a second area. According to an embodiment, the instructions may, when executed by the at least one processor individually or collectively, cause the electronic device to, based on the first size information, display an execution screen of the first application in the first area having the first size and, based on the second size information, display an execution screen of the second application in the second area having the second size. According to an embodiment, the instructions may, when executed by the at least one processor individually or collectively, cause the electronic device to, according to the split screen mode, display, using the display, a split screen divided into the first area and the second area, wherein the first area and the second area are arranged not to overlap each other in the split screen.

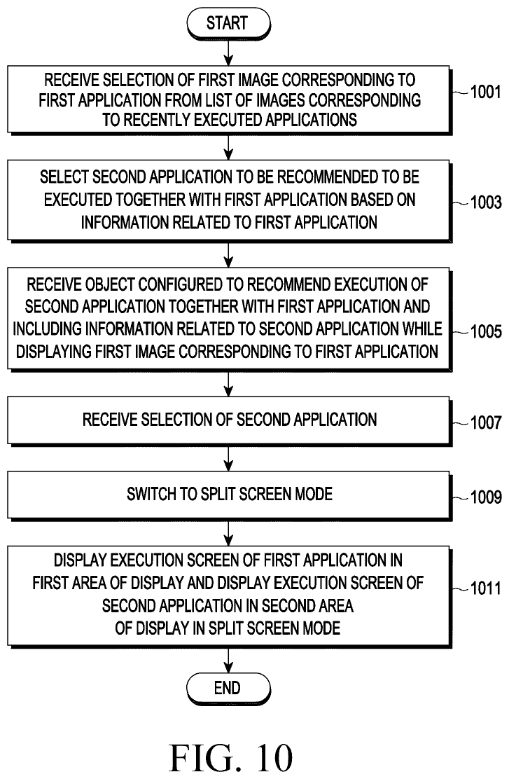

FIG. 10 is a flowchart illustrating an operation of executing a split screen mode in an electronic device according to an embodiment. The operations of executing the split screen mode may include operations 1001 to 1011. In the example shown in FIG. 10, each operation may be sequentially performed, but embodiments are not limited thereto. For example, the order of the operations may be changed, and at least two operations may be performed in parallel or other operations may be added.

At operation 1001, the electronic device (e.g., at least one of the electronic device 101 of FIG. 1 and the electronic device 201 of FIGS. 2A and 2B) may receive a selection of a first image corresponding to a first application from a list of the images corresponding to the recently executed applications.

According to an embodiment, the electronic device may receive a selection of the first image corresponding to the first application based on the first user input from the list of the images corresponding to the recently executed applications.

At operation 1003, the electronic device (e.g., at least one of the electronic device 101 of FIG. 1 and the electronic device 201 of FIGS. 2A and 2B) may select a second application to be recommended to be executed together with the first application based on information related to the first application.

According to an embodiment, based on receiving the selection of the first image corresponding to the first application, the electronic device may select the application having the highest usage frequency among the at least one application executed together with the first application as the second application in the split screen mode based on the information related to the first application using the AI model 231.

According to an embodiment, based on receiving the selection of the first image corresponding to the first application, the electronic device may select the application having a longest usage time among the at least one application executed together with the first application as the second application in the split screen mode based on the information related to the first application using the AI model 231.

According to an embodiment, based on receiving the selection of the first image corresponding to the first application, the electronic device may select the most recently used application among the at least one application executed together with the first application as the second application in the split screen mode based on the information related to the first application using the AI model 231.

According to an embodiment, based on receiving the selection of the first image corresponding to the first application, the electronic device may analyze content (e.g., text or image) included in the last screen displayed by the first application and select the application related to the analyzed content (result of the analyzed content) as the second application using the AI model 231.

According to an embodiment, the information related to the first application may include the type of the first application, the type of the application executed together with the first application in the split screen mode, the number of executions of the application executed together with the first application in the split screen mode, the execution time of the application executed together with the first application, the type of the recent application executed together with the first application, content (e.g., text or image) information included in the last screen displayed by the first application, first size information about the size of the first area in which the first application is executed in the split screen mode, second size information about the size of the second area in which the second application is executed in the split screen mode and, when a plurality of user IDs are present in the electronic device, user information (user ID) using the first application.

According to an embodiment, the electronic device may generate or update the information related to the first application using the AI model (e.g., the AI model 231 of FIG. 2B) when executing the first application.

At operation 1005, the electronic device (e.g., at least one of the electronic device 101 of FIG. 1 and the electronic device 201 of FIGS. 2A and 2B) may display an object (e.g., recommendation message) configured to recommend execution of the second application together with the first application and including the information related to the second application while displaying the first image corresponding to the first application.

According to an embodiment, the electronic device may display an object (e.g., recommendation message) configured to recommend execution of the second application together with the first application and including the information related to the second application while displaying the first image corresponding to the first application through the display (e.g., the display 260 of FIG. 2A) of the electronic device.

At operation 1007, the electronic device (e.g., at least one of the electronic device 101 of FIG. 1 and the electronic device 201 of FIGS. 2A and 2B) may receive a selection of the second application.

According to an embodiment, the electronic device may receive a selection of the second application based on the second user input while displaying the first image corresponding to the first application and the object (e.g., recommendation message) configured to recommend execution of the second application together with the first application and including the information related to the second application through the display (e.g., the display 260 of FIG. 2A) of the electronic device.

At operation 1009, the electronic device (e.g., at least one of the electronic device 101 of FIG. 1 and the electronic device 201 of FIGS. 2A and 2B) may switch to the split screen mode.

According to an embodiment, the electronic device may receive a selection of the second application based on the second user input and, when switching to the split screen mode, determine first size information about the size of a first area in which the first application has been (or is) executed in the split screen mode and second size information about the size of a second area in which the second application has been (or is) executed in the split screen mode.

At operation 1011, the electronic device (e.g., at least one of the electronic device 101 of FIG. 1 and the electronic device 201 of FIGS. 2A and 2B) may display the execution screen of the first application in the first area of the display and display the execution screen of the second application in the second area of the display in the split screen mode.

According to an embodiment, when switching to the split screen mode, the electronic device may display the execution screen of the first application in the first area of the display (e.g., the display 260 of FIG. 2A) having the first size based on the first size information and display the execution screen of the second application in the second area of the display having the second size based on the second size information.

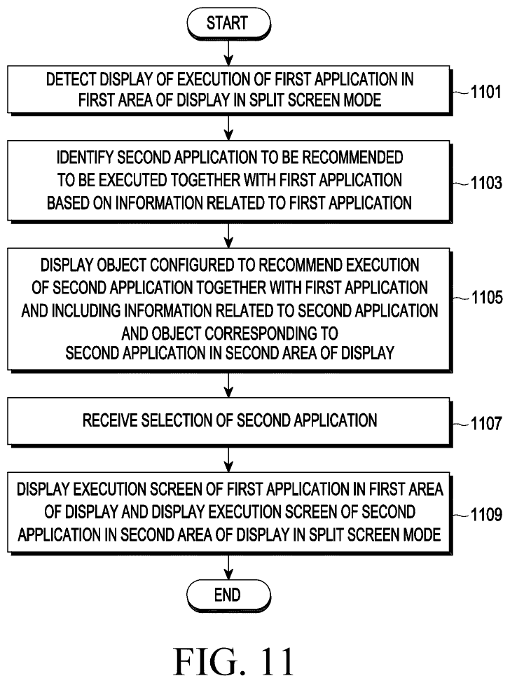

FIG. 11 is a flowchart illustrating an operation of executing a split screen mode in an electronic device according to an embodiment. The operations of executing the split screen mode may include operations 1101 to 1109. In the following embodiment, each operation may be sequentially performed, but embodiments are not limited thereto. For example, the order of the operations may be changed, and at least two operations may be performed in parallel or other operations may be added.

At operation 1101, the electronic device (e.g., at least one of the electronic device 101 of FIG. 1 and the electronic device 201 of FIGS. 2A and 2B) may detect the display of the execution of the first application in the first area of the display in the split screen mode.

According to an embodiment, the electronic device may receive a selection of the first image corresponding to the first application based on the first user input from the list of the images corresponding to the recently executed applications and determine that the first application is to be executed in the split screen mode based on the user input.

At operation 1103, the electronic device (e.g., at least one of the electronic device 101 of FIG. 1 and the electronic device 201 of FIGS. 2A and 2B) may determine a second application to be recommended to be executed together with the first application based on information related to the first application.

According to an embodiment, when detecting the display of the execution screen of the first application selected based on the user input in the first area of the display (e.g., the display 260 of FIG. 2A) in the split screen mode, the electronic device may select the application having the highest usage frequency among the at least one application executed together with the first application as the second application in the split screen mode based on the information related to the first application using the AI model (e.g., the AI model 231 of FIG. 2B).

According to an embodiment, when detecting the display of the execution screen of the first application selected based on the user input in the first area of the display in the split screen mode, the electronic device may select the application having the longest usage time among the at least one application executed together with the first application as the second application in the split screen mode based on the information related to the first application using the AI model.

According to an embodiment, when detecting the display of the execution of the first application selected based on the user input in the first area of the display in the split screen mode, the electronic device may select the most recently used application among the at least one application executed together with the first application as the second application in the split screen mode based on the information related to the first application using the AI model 231.

According to an embodiment, when detecting the display of the execution of the first application selected based on the user input in the first area of the display in the split screen mode, the electronic device may analyze content (e.g., text or image) included in the last screen displayed by the first application and select the application related to the analyzed content as the second application using the AI model.

At operation 1105, the electronic device (e.g., at least one of the electronic device 101 of FIG. 1 and the electronic device 201 of FIGS. 2A and 2B) may display an object (e.g., recommendation message) configured to recommend execution of the second application together with the first application and including the information related to the second application and the object corresponding to the second application in the second area of the display.

According to an embodiment, based on the second application being selected as the recommended application, in the split screen mode, the electronic device may display the execution screen of the first application in the first area of the display (e.g., the display 260 of FIG. 2A) and may display the object corresponding to the second application and the object (e.g., recommendation message) including the information related to the second application and configured to recommend execution of the second application together with the first application in the second area of the display.

At operation 1107, the electronic device (e.g., at least one of the electronic device 101 of FIG. 1 and the electronic device 201 of FIGS. 2A and 2B) may receive a selection of the second application.

According to an embodiment, the electronic device may receive a selection of the object corresponding to the second application based on the second user input while displaying the execution screen of the first application in the first area of the display 260 and displaying the object corresponding to the second application and the object (e.g., recommendation message) in the second area of the display 260 in the split screen mode.

At operation 1109, the electronic device (e.g., at least one of the electronic device 101 of FIG. 1 and the electronic device 201 of FIGS. 2A and 2B) may display the execution screen of the first application in the first area of the display and display the execution screen of the second application in the second area of the display in the split screen mode.

According to an embodiment, based on receiving a selection of the object corresponding to the second application based on the second user input, the electronic device may determine first size information about the size of a first area in which the first application has been (or is) executed in the split screen mode and second size information about the size of a second area in which the second application has been (or is) executed in the split screen mode.

According to an embodiment, based on receiving a selection of the object corresponding to the second application based on the second user input, the electronic device may display the execution screen of the first application in the first area of the display 260 having the first size based on the first size information and display the execution screen of the second application in the second area of the display 260 having the second size based on the second size information.

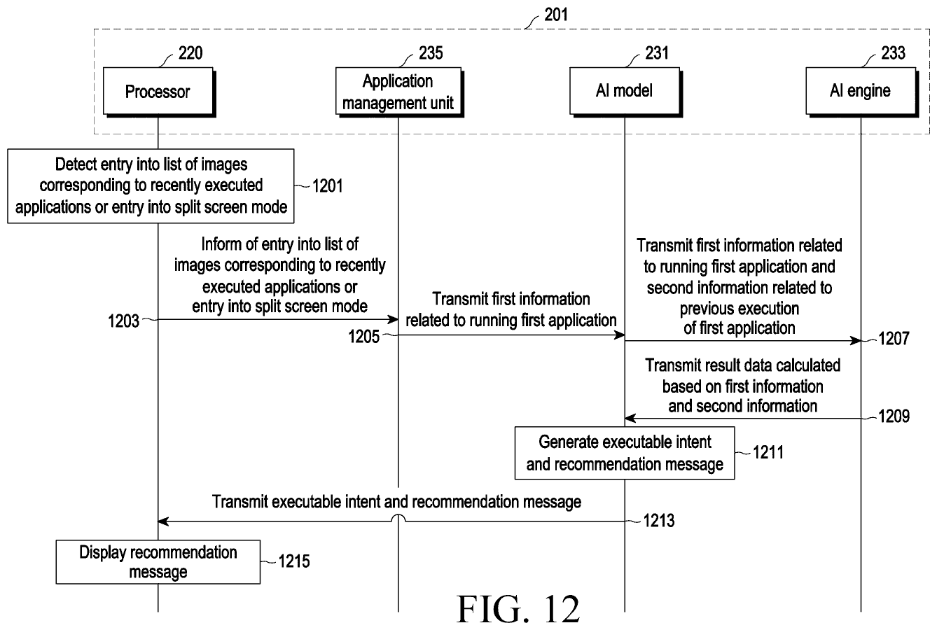

FIG. 12 is a flowchart illustrating an operation of providing a recommendation message in an electronic device according to an embodiment. The operations of executing the split screen mode may include operations 1201 to 1215. In the following embodiment, each operation may be sequentially performed, but embodiments are not limited thereto. For example, the order of the operations may be changed, and at least two operations may be performed in parallel or other operations may be added.

At operation 1201, the processor 220 (e.g., the processor 220 of FIG. 2A) may detect entry into the display of the list of the images corresponding to the recently executed applications or entry into the split screen mode.

According to an embodiment, the processor 220 may detect the entry into the display of the list of the images corresponding to the recently executed applications or the entry into the split screen mode based on an input of the user of the electronic device 201.

At operation 1203, the processor 220 (e.g., the processor 220 of FIG. 2A) may inform the application management unit 235 of the entry into the list of the images corresponding to the recently executed applications or the entry of the split screen mode.

At operation 1205, the application management unit 235 (e.g., the application management unit 235 of FIG. 2B) may transmit first information related to the first application which is running too the AI model 231.

According to an embodiment, the application management unit 235 may detect the first application which is executed based on an input of the user of the electronic device 201 in the split screen mode or the list of the images corresponding to the recently executed applications and determine the first information related to the running first application.

At operation 1207, the AI model 231 (e.g., the AI model 231 of FIG. 2B) may transmit the first information related to the running first application and second information related to the previous execution of the first application to the AI engine 233.

The AI model 231 according to an embodiment may transmit application-related data (e.g., the first information related to the running first application and the second information related to the previous execution of the first application) received from the data collection unit (e.g., the data collection unit 237 of FIG. 2B) to the AI engine 233.

At operation 1209, the AI engine 233 (e.g., the AI engine 233 of FIG. 2B) may transmit result data calculated based on the first information and the second information to the AI model 231.

According to an embodiment, when receiving application-related data (first information related to the first application which is running and second information related to the previous execution of the first application) from the AI model 231, the AI engine 233 may produce (calculate) the result data for generating a recommendation message and an executable intent using a prompt or RAG and transmit the result data to the AI model 231.

At operation 1211, the AI model 231 (e.g., the AI model 231 of FIG. 2B) may generate an executable intent and a recommendation message.

According to an embodiment, the AI model 231 may generate an executable intent and a recommendation message recommending execution of the second application together with the first application in the split screen mode based on result data calculated based on the first information and second information received from the AI engine 233.

At operation 1213, the AI model 231 (e.g., the AI model 231 of FIG. 2B) may transmit the executable intent and the recommendation message to the processor 220.

At operation 1215, the processor 220 (e.g., the processor 220 of FIG. 2A) may display the recommendation message.

According to an embodiment, a method for executing a split screen mode in an electronic device (e.g., at least one of the electronic device 101 of FIG. 1 and the electronic device 201 of FIGS. 2A and 2B) may include displaying, using a display of the electronic device, a first image corresponding to a first application from a list of images corresponding to recently executed applications. According to an embodiment, the method may include, based on receiving a first user input for selecting the first image corresponding to the first application, displaying, through the display, an object, which is configured to recommend execution of a second application together with the first application and includes information related the second application. The second application may be selected using an AI model based on information related to the first application. According to an embodiment, the method may include, based on receiving a second user input for selecting the object corresponding to the second application, displaying an execution screen of the first application in a first area of the display and an execution screen of the second application in a second area of the display in a split screen mode.

According to an embodiment, the method may further include,, selecting, as the second application, an application with a highest usage frequency from among applications used together with the first application in the split screen mode.

According to an embodiment, the method may further include, selecting an application with a longest usage time among applications used together with the first application in the split screen mode as the second application.

According to an embodiment, the method may further include, using the AI model, analyzing content included in a last screen displayed by the first application based on the information related to the first application and selecting, as the second application, an application related to the analyzed content.

According to an embodiment, the method may further include, based on the information related to the first application, selecting a plurality of second applications recommended to be executed together with the first application using the AI model. According to an embodiment, the method may further include displaying, using the display, a plurality of objects corresponding to the plurality of second applications while the first image corresponding to the first application is displayed.

According to an embodiment, the method may further include, based on determining that the AI model is unable to select the second application based on the information related to the first application, selecting, using the AI model, a third application recommended to be executed together with the first application based on data obtained through a server.

According to an embodiment, the method may further include determining first size information about a first size of a first and second size information about a second size of a second area. According to an embodiment, the method may further include, based on the first size information, displaying an execution screen of the first application on the first area having the first size and, based on the second size information, displaying an execution screen of the second application on the second area having the second size, and according to the split screen mode, displaying, using the display, a split screen divided into the first area and the second area. wherein the first area and the second area are arranged not to overlap each other.

The electronic device according to an embodiment of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, expressions such as “at least one of,” when preceding a list of elements, modify the entire list of elements and do not modify the individual elements of the list. For example, the expression, “at least one of A, B, and C,” should be understood as including only A, only B, only C, both A and B, both A and C, both B and C, or all of A, B, and C.

As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in the form of an application-specific integrated circuit (ASIC).

An embodiment of the disclosure may be implemented as software (e.g., the program 140) including one or more instructions that are stored in a storage medium (e.g., at least one of internal memory 136 and external memory 138) that is readable by a machine (e.g., at least one of the electronic device 101 and the electronic device 301). For example, a processor (e.g., the processor 120) of the machine (e.g., the electronic device 301) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., at least one of downloaded and uploaded) online via an application store (e.g., Play Store™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., at least one of a module and a program) of the above-described components may include a single entity or multiple entities. Some of the plurality of entities may be separately disposed in different components. According to an embodiment, one or more of the above-described components may be omitted, or one or more other components may be added. Alternatively or additionally, a plurality of components (e.g., at least one of modules and programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a display;
at least one processor, and
memory storing instructions that, when executed by the at least one processor individually or collectively, cause the electronic device to:
display, using the display, a first image corresponding to a first application from a list of images corresponding to recently executed applications,
based on a first user input for selecting the first image corresponding to the first application being received, display, using the display, an object configured to recommend execution of a second application together with the first application and including information related the second application, wherein the second application is selecting using an artificial intelligence (AI) model based on information related to the first application, and
based on a second user input for selecting the object being received, display an execution screen of the first application in a first area of the display and an execution screen of the second application in a second area of the display according to a split screen mode.

2. The electronic device of claim 1,
wherein the instructions, when executed by the at least one processor individually or collectively, further cause the electronic device to:
select, as the second application, an application having a highest usage frequency from among applications used together with the first application in the split screen mode.

3. The electronic device of claim 1,
wherein the instructions, when executed by the at least one processor individually or collectively, further cause the electronic device to:
select, as the second application, an application having a longest usage time from among applications used together with the first application in the split screen mode.

4. The electronic device of claim 1,
wherein the instructions, when executed by the at least one processor individually or collectively, further cause the electronic device to:
using the AI model, analyze content included in a last screen displayed by the first application based on the information related to the first application, and
select, as the second application, an application related to the analyzed content.

5. The electronic device of claim 1,
wherein the instructions, when executed by the at least one processor individually or collectively, further cause the electronic device to:
based on the information related to the first application, select a plurality of second applications recommended to be executed together with the first application using the AI model, and
display, using the display, a plurality of objects corresponding to the plurality of second applications while the first image corresponding to the first application is displayed.

6. The electronic device of claim 1,
wherein the instructions, when executed by the at least one processor individually or collectively, further cause the electronic device to:
based on determining that the AI model is unable to select the second application based on the information related to the first application, select, using the AI model, a third application recommended to be executed together with the first application based on data obtained through a server.

7. The electronic device of claim 1,
wherein the instructions, when executed by the at least one processor individually or collectively, further cause the electronic device to:
determine first size information about a first size of the first area and second size information about a second size of the second area,
based on the first size information, display an execution screen of the first application on the first area having the first size and, based on the second size information, display an execution screen of the second application on the second area having the second size, and
according to the split screen mode, display, using the display, a split screen divided into the first area and the second area,
wherein the first area and the second area are arranged not to overlap each other in the split screen.

8. A method for executing a split screen mode in an electronic device, the method comprising:
displaying, using a display of the electronic device, a first image corresponding to a first application from a list of images corresponding to recently executed applications;
based on a first user input for selecting the first image corresponding to the first application being received, displaying, using the display, an object configured to recommend execution of a second application together with the first application and including information related the second application, wherein the second application is selected using an artificial intelligence (AI) model based on information related to the first application; and
based on a second user input for selecting the object corresponding to the second application being received, displaying an execution screen of the first application in a first area of the display and an execution screen of the second application in a second area of the display in the split screen mode.

9. The method of claim 8, further comprising:
based on the information related to the first application, selecting, as the second application, an application having a highest usage frequency among applications used together with the first application in the split screen mode.

10. The method of claim 8, further comprising:
based on the information related to the first application, selecting, as the second application, an application having a longest usage time among applications used together with the first application in the split screen mode.

11. The method of claim 8, further comprising:
by using the AI model, analyzing content included in a last screen displayed by the first application based on the information related to the first application and selecting, as the second application, an application related to the analyzed content.

12. The method of claim 8, further comprising:
based on the information related to the first application, selecting a plurality of second applications recommended to be executed together with the first application using the AI model; and
displaying, using the display, a plurality of objects respectively corresponding to the plurality of second applications while the first image corresponding to the first application is displayed.

13. The method of claim 8, further comprising:
based on determining that the AI model is unable to select an application recommended to be executed together with the first application based on the information related to the first application, selecting, using the AI model, a third application recommended to be executed together with the first application based on data obtained through a server.

14. The method of claim 8, further comprising:
determining first size information about a first size of the first area and second size information about a second size of the second area; and
based on the first size information, displaying an execution screen of the first application in the first area having the first size, and based on the second size information, displaying an execution screen of the second application in the second area having the second size, and
according to the split screen mode, displaying, using the display, a split screen divided into substantially two areas including the first area and the second area,
wherein the first area and the second area are arranged not to overlap each other in the split screen.

15. A non-transitory computer-readable storage medium storing instructions which, when executed by at least one processor of a wearable electronic device, cause the electronic device to:
displaying, using a display of the electronic device, a first image corresponding to a first application from a list of images corresponding to recently executed applications;
based on a first user input for selecting the first image corresponding to the first application being received, displaying, using the display, an object configured to recommend execution of a second application together with the first application and including information related the second application, wherein the second application is selected using an artificial intelligence (AI) model based on information related to the first application; and
based on a second user input for selecting the object corresponding to the second application being received, displaying an execution screen of the first application in a first area of the display and an execution screen of the second application in a second area of the display according to a split screen mode.
